(19) United States
(12) Patent Application Publication
(10) Pub. No.: US 2016/0299582 A1
(43) Pub. Date: Oct. 13, 2016

(54) INFORMATION INPUT AND OUTPUT DEVICE AND ENCODING MODULE THEREOF

(71) Applicant: COMPAL ELECTRONICS, INC., Taipei City (TW)

(72) Inventors: Chih-Hsien Wei, Taipei City (TW); Chung-Yu Kao, Taipei City (TW)

(21) Appl. No.: 14/850,605

(22) Filed: Sep. 10, 2015

(30) Foreign Application Priority Data
Apr. 8, 2015 (TW) 104111349

(51) Int. Cl. G06F 3/0362; G01D 5/14; G06F 1/16; G01D 11/24

(52) U.S. Cl. CPC G06F 3/0362; G01D 11/245; G01D 5/14; G06F 1/163; G06F 1/1684

(57) ABSTRACT

An information input and output device comprises a casing, an outer ring body, a magnetic wheel and an encoding module. The casing comprises an annulus sidewall and a base. A first surface of the outer ring body is close to the annulus sidewall. A single groove of the outer ring body is formed on the first surface. The magnetic wheel is fixed into the groove. The outer ring body and the magnetic wheel are rotatably disposed around an outer wall surface of the annulus sidewall. The encoding module comprises a circuit board and an information processing unit. When the outer ring body is rotated, the information processing unit is configured to detect a number of times and a direction in changes of the magnetic field of the magnetic wheel and convert the detected results into a position information and a direction information.

### CROSS-REFERENCE TO RELATED APPLICATION

This application claims priority from Taiwan Patent Application No. 104111349, filed on Apr. 8, 2015, the contents of which are hereby incorporated by reference in their entirety for all purposes.

### FIELD OF THE INVENTION

The present invention relates to an information input and output device and an encoding module, and more particularly to an information input and output device and an encoding module for wearable intelligent accessories.

### BACKGROUND OF THE INVENTION

With the increased develops and growths in the intelligent devices, a variety of high-tech products for example smart phones, smart home appliances and wearable intelligent accessories are announced one after another, and those products have been introduced into our daily life. A user is able to browse many kinds of information through the intelligent devices rapidly and conveniently, and is able to select functions or input information by using the input interfaces of the intelligent devices.

Generally, a touch panel is employed as an input interface of the intelligent device for selecting a purposed function and inputting necessary information. Nowadays, wearable intelligent accessories such as smart glasses and smart watches are the major products needed to be developed. To meet with the requirements of being carried on easily, saving materials and being stored easily, most of the wearable intelligent accessories are expected to be developed in a lightweight style, a thin style and a waterproof and dustproof style. The smart glasses and the smart watches, however, have no enough spaces to adopt touch panels for the purpose of satisfying the light and thin style. Even if the smart glasses and the smart watches are able to adopt touch panels, the size of the touch panels are constrained, and that may lead to an inconvenience and a reduction of flexibility when manipulating those smart watches and smart glasses.

Besides, users may be exposed to dust, moisture and splash water in their daily life frequently. Thus, to ensure that the wearable intelligent accessories keep operating properly, there is a need of enhancing their waterproof ability and dustproof ability, so that damages to the functions of the wearable intelligent accessories caused by dust and water can be avoided. Consequently, finding an effective way to enhance the waterproof ability and the dustproof ability of the wearable intelligent accessory has become an important issue.

Therefore, there is a need of providing an information input and output device and an encoding module so as to obviate the drawbacks encountered by the prior arts.

### SUMMARY OF THE INVENTION

An object of the present invention provides an information input and output device and an encoding module for wearable intelligent accessories. By embedding a magnetic wheel into an outer ring body, the magnetic wheel is synchronously rotated with the outer ring body. When the outer ring body is rotated by a user, an encoding operation is performed by an interior sensor disposed in the information input and output device. Consequently, the issues encountered by the prior arts, such as hard to be developed in a light and thin style, poor waterproof ability and dustproof ability and inconvenient in manipulation can be overcome.

Another object of the present invention provides an information input and output device and an encoding module for wearable intelligent accessories. By embedding a magnetic wheel into an outer ring body, the magnetic wheel is synchronously rotated with the outer ring body. When the outer ring body is rotated by a user, an encoding operation is performed by an interior sensor disposed in the information input and output device, and the information is inputted to the wearable intelligent accessory with a sealed structures by measuring the changes in the magnetic field of the magnetic wheel. Consequently, the wearable intelligent accessory with the information input and output device can be developed in a light and thin style, has reliable waterproof and dustproof ability, and can be operated easily.

In accordance with an aspect of the present invention, there is provided an information input and output device. The information input and output device comprises a casing, an outer ring body, a magnetic wheel and an encoding module. The casing comprises an annulus sidewall and a base. The outer ring body comprises a first surface and a single groove. The first surface is close to the annulus sidewall of the casing. The single groove is formed on the first surface. The magnetic wheel is fixed into the groove. The encoding module comprises a circuit board and an information processing unit. The circuit board is fixed on the base of the casing. The information processing unit is fixed on the circuit board. The outer ring body and the magnetic wheel are rotatably disposed around an outer surface of the annulus sidewall of the casing. When the outer ring body is rotated and the magnetic wheel is rotated with the outer ring body synchronously, and the information processing unit is configured to detect the number of times and the directions in the changes of the magnetic field of the magnetic wheel and convert the detected results into a position information and a direction information.

In accordance with another aspect of the present invention, there is provided an encoding module for an information input and output device. The information input and output device comprises a casing, an outer ring body and a magnetic wheel. The casing comprises an annulus sidewall and a base. The outer ring body comprises a first surface and a single groove. The first surface is close to the annulus sidewall, and the groove is formed on the first surface. The magnetic wheel is fixed into the groove. The encoding module comprises a circuit board and an information processing unit. The circuit board is fixed on the base of the casing. The information processing unit is fixed on the circuit board. The outer ring body and the magnetic wheel are rotatably disposed around an outer surface of the annulus sidewall of the casing. When the outer ring body is rotated and the magnetic wheel is rotated with the outer ring body synchronously, and the information processing unit is configured to detect the number of times and the directions in the changes of the magnetic field of the magnetic wheel, and convert the detected results into a position information and a direction information.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates an information input and output device according to an embodiment of the present invention;

FIG. 2 is an exploded view of the information input and output device of FIG. 1;

FIG. 3 is a detailed view of the casing of FIG. 2; and

FIG. 4 is a partial schematic view of the information input and output device of FIG. 1.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

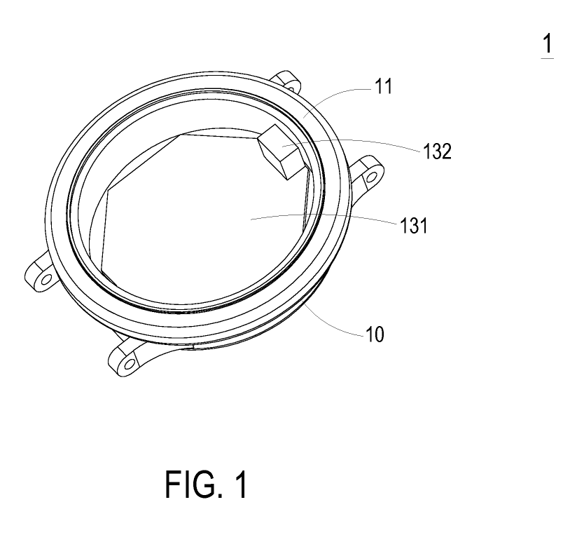

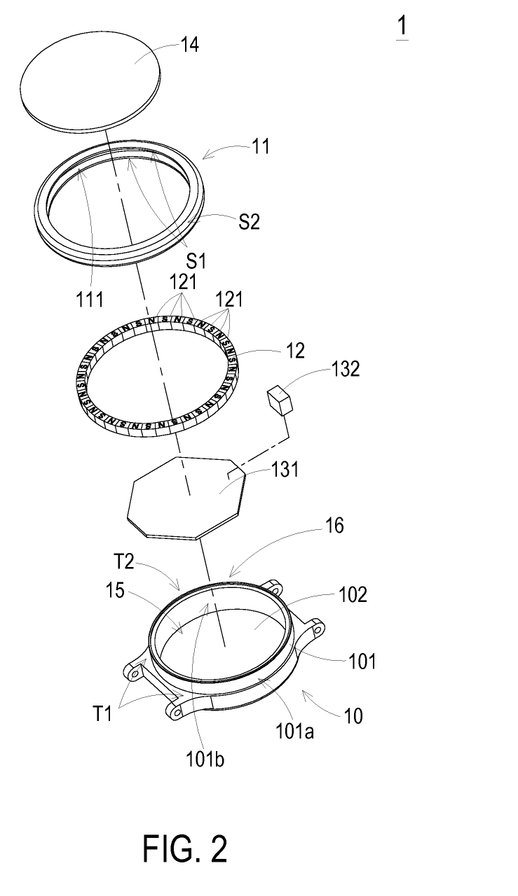

FIG. 1 schematically illustrates an information input and output device according to an embodiment of the present invention. FIG. 2 is an exploded view of the information input and output device of FIG. 1. Please refer to FIGS. 1 and 2. The information input and output device 1 comprises a casing 10, an outer ring body 11, a magnetic wheel 12, an encoding module 13 and a protection cover 14. The casing 10 comprises an annulus sidewall 101 and a base 102. In some embodiments, the casing 10 is formed of non-permeability materials. Namely, the annulus sidewall 101 and the base 102 are both formed of non-permeability materials. Preferably, the annulus sidewall 101 and the base 102 are formed into a single piece, but it is not limited thereto. Alternatively, the annulus sidewall 101 is connected with the base 102 by way of engaging, adhering or screwing.

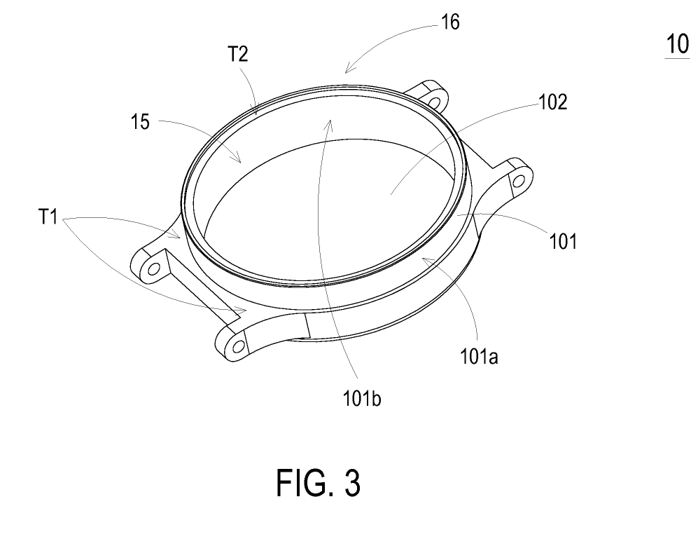

FIG. 3 is a detailed view of the casing of FIG. 2. Please refer to FIGS. 2 and 3. The annulus sidewall 101 is disposed on and surrounding along the edge of the base 102, and a receiving space 15 and an opening 16 are defined by the annulus sidewall 101 and the base 102. The encoding module 13 is disposed in the receiving space 15. In addition, the protection cover 14 is disposed on the opening 16 of the annulus sidewall 101 and opposite to the base 102, so that the opening 16 and the receiving space 15 is covered and sealed by the protection cover 14 to form an airtight space. Consequently, the encoding module 13 is completely accommodated within the receiving space 15 through the casing 10 and the protection cover 14 so that it is capable of being completely isolated from the environment (i.e. the outside of the information input and output device 1). Under this circumstance, the information input and output device 1 with reliable waterproof and dustproof ability can be provided. In some embodiments, the annulus sidewall 101 comprises an outer wall surface 101a and an inner wall surface 101b. The outer wall surface 101a of the annulus sidewall 101 is opposed to the inner wall surface 101b. In other words, when the information input and output device 1 is completely assembled, the outer wall surface 101a of the annulus sidewall 101 is exposed to the outside of the information input and output device 1, and the inner wall surface 10 lb of the annulus sidewall 101 is disposed in the inside of the information input and output device 1. In an embodiment, the outer wall surface 101a of the annulus sidewall 101 has a first stepped part T1, and the first stepped part T1 is extended outwardly from the outer wall surface 101a. When the information input and output device 1 is completely assembled, the outer ring body 11 is disposed on the first stepped part T1, so that the outer ring body 11 is supported by the first stepped part T1, and the detachment or slippage of the outer ring body 11 can be avoided. In other embodiments, the inner wall surface 101b of the annulus sidewall 101 has a second stepped part T2. The second stepped part T2 is located at an end portion of the inner wall surface T2 and close to the opening 16, and the second stepped part T2 is formed by a depression in a direction from the inner wall surface 101b to the outer wall surface 101a. When the information input and output device 1 is completely assembled, the protection cover 14 is disposed on the second stepped part T2, so that the protection cover 14 is supported by the second stepped part T2. Besides the purposes of supporting and fixing, the waterproof and dust proof ability of the information input and output device 1 can be enhanced by employing the first stepped part T1 and the second stepped part T2.

Moreover, as shown in FIGS. 2 and 3, the outer ring body 11 comprises a first surface S1, a second surface S2 and a single groove 111. The first surface S1 is opposed to the second surface S2, the first surface S1 is close to the annulus sidewall 101, and the annulus sidewall 101 is surrounded by the first surface S1 of the outer ring body 11. The groove 111 is formed on the first surface S1, and the magnetic wheel 12 is fixed into the groove 111. Furthermore, the first surface Si and the second surface S2 are collectively forming an entire surface of the outer ring body 11. For example, the first surface S1 is an inner circular surface of the outer ring body 11, and the second surface S2 is the rest surface area of the outer ring body 11 except the surface area of the first surface S1. In this embodiment, the groove 111 is extended from the first surface S1 toward the second surface S2, but the groove 111 does not penetrate through the second surface S2, substantially. In some embodiments, the magnetic wheel 12 includes a plurality of magnet units 121, which are arranged sequentially. As shown in FIG. 2, each magnet unit 121 includes N pole and S pole, and any two adjacent magnet units 121 are attracted by each other so as to form a complete ring structure. The number of the magnet units 121 is not limited and can be changed according to the practical requirements. In other words, the number of the magnet units 121 is varied from two to twenty according to the practical requirements, but it is not limited thereto. Preferably, the magnetic wheel 12 includes eight magnet units 121. Namely, eight N poles and eight S poles are arranged alternatively and combined as a ring structure. In other embodiments, a shape of the groove 111 matches a shape of the magnetic wheel 12, and the magnetic wheel 12 is stably fixed into the groove 111 of the outer ring body 12 by the way of engaging or adhering, so that the magnetic wheel 12 is synchronously rotated with the outer ring body 11. Consequently, the problems leading to a failure in exerting the magnetic attraction, caused by separation of the magnetic wheel 12 and the outer ring body 11 or sliding between the magnetic wheel 12 and the outer ring body 11 can be avoided.

Please refer to FIG. 2 again. The encoding module 13 comprises a circuit board 131 and an information processing unit 132. The circuit board 131 is fixed on the base 102 of the casing 10. For example, the circuit board 131 is fixed on the base 102 of the casing 10 by way of engaging or screwing, so that a detachment of the circuit board 131 can be avoided. The information processing unit 132 is fixed on the circuit board 131, and the information processing unit 132 is electrically connected with the circuit board 131. In this embodiment, the information processing unit 132 includes two magnetic sensors 132a, 132b. Preferably, the magnetic sensor is a hall sensor. The two magnetic sensors 132a, 132b are disposed adjacent to the inner wall surface 101b of the annulus sidewall 101, so that the directions in the changes of the magnetic field of the magnetic wheel 12 can be detected accurately. Accordingly, a rotation direction of the outer ring body 11 and the magnetic wheel 12 is determined. In other words, the two magnetic sensors 132a, 132b are employed to determine whether the outer ring body 11 and the magnetic wheel 12 are rotated in a clockwise direction or a counterclockwise direction.

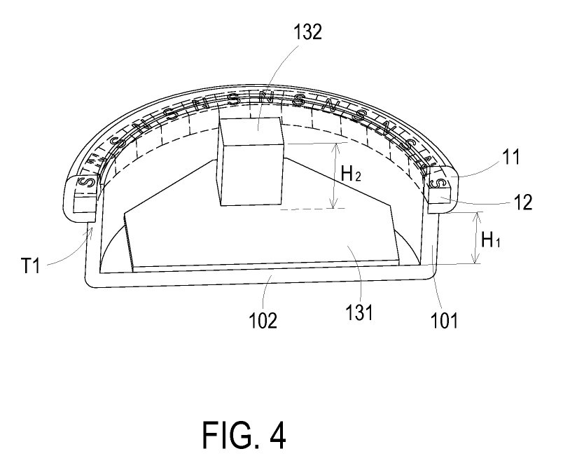

FIG. 4 is a partial schematic view of the information input and output device of FIG. 1. As shown in FIGS. 2 and 4, when the information input and output device 1 is completely assembled, the outer ring body 11 is rotatably disposed around the outer wall surface 101a of the annulus sidewall 101 of the casing 10, and the outer ring body 11 is supported by the first stepped part T1. When the outer ring body 11 is rotated, the magnetic wheel 12 which is fixed into the groove 111 of the outer ring body 11 is rotated synchronously with the outer ring body 11 in the same direction. The magnetic pole and the intensity of the magnetic field of the magnetic wheel 12 at a specific position are detected through the information processing unit 132. Namely, when the magnetic wheel 12 is rotated, the magnetic poles and magnetic field of the magnetic wheel 12 at a position corresponding to the magnetic sensors 132a, 132b of the information processing unit 132 will be changed correspondingly. By detecting and determining whether the magnetic field of the magnetic wheel 12 at the position corresponding to the magnetic sensors 132a, 132b of the information processing unit 132 is N pole magnetic field or S pole magnetic field, the changes of the magnetic field can be detected by the information processing unit 132. Therefore, the number of times and the directions in the changes of the magnetic field of the magnetic wheel 12 are detected by the information processing unit 132 when the magnetic wheel 12 is rotated, and the detected results are encoded and converted into a position information and a direction information by the information processing unit 132.

Please refer to FIG. 4, in some embodiments, a first length H1 is the minimum vertical distance defined from the first stepped part T1 to the base 102. A second length H2 is the maximum vertical distance defined from the top surface of the information processing unit 132 to the base 102. In this embodiment, the first length H1 is less than the second length H2. Consequently, when the information input and output device 1 is assembled completely, the magnetic wheel 12 disposed in the outer ring body 11 is opposed to the information processing unit 132 via the annulus sidewall 101. Under this circumstance, the number of times and the directions in the changes of the magnetic field of the magnetic wheel 12 can be detected more accurately.

In other embodiments, the circuit board 131 further comprises at least one integrated circuit. The at least one integrated circuit is fixed on the circuit board 131 and electrically connected with the circuit board 131. In addition, the integrated circuit is electrically connected with the information processing 132 via the circuit board 131. Under this circumstance, the position information and the direction information generated by the information processing unit 132 are transmitted to the at least one integrated circuit, and then the position information and the direction information are further converted into a specific information or command by the integrated circuit. Consequently, users can rotate the outer ring body 11 by pushing against the second surface S2 of the outer ring body 11 through their fingers, and then the rotation of the outer ring body 11 can be converted into a specific information or command, such that the object of using the outer ring body 11 as an input interface is achieved.

From the above descriptions, the present disclosure provides an information input and output device and an encoding module. By embedding a magnetic wheel into an outer ring body, the magnetic wheel is synchronously rotated with the outer ring body. When the outer ring body is rotated by a user, an encoding operation is performed by an interior sensor disposed in the information input and output device. Consequently, the issues encountered by the prior arts, such as hard to be developed in a light and thin style, poor waterproof ability and dustproof ability and the inconvenient in manipulation, can be overcome. In addition, the information is inputted to a wearable intelligent accessory with a sealed structure by measuring the changes in the magnetic field of the magnetic wheel. Consequently, the wearable intelligent accessory with the information input and output device can be developed in a light and thin style, has reliable waterproof and dustproof ability, and can be operated easily.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An information input and output device, comprising:
a casing comprising an annulus sidewall and a base;
an outer ring body comprising a first surface and a single groove, wherein the first surface is close to the annulus sidewall of the casing, and the groove is formed on the first surface;
a magnetic wheel fixed into the groove; and
an encoding module, comprising:
a circuit board fixed on the base of the casing; and
an information processing unit fixed on the circuit board,
wherein the outer ring body and the magnetic wheel are rotatably disposed around an outer wall surface of the annulus sidewall of the casing, when the outer ring body is rotated and the magnetic wheel is rotated with the outer ring body synchronously, and the information processing unit is configured to detect a number of times and a direction in changes of the magnetic field of the magnetic wheel and convert the detected results into a position information and a direction information.

2. The information input and output device according to claim 1, wherein the casing is formed of a non-permeability material.

3. The information input and output device according to claim 1, wherein the outer wall surface of the annulus sidewall has a first stepped part, and the outer ring body is disposed on the first stepped part.

4. The information input and output device according to claim 3, wherein a vertical distance from the first stepped part to the base is less than a vertical distance from an top surface of the information processing unit to the base.

5. The information input and output device according to claim 1, wherein the annulus sidewall is disposed on and surrounding along an edge of the base, and a receiving space and an opening are defined by the annulus sidewall and the base.

6. The information input and output device according to claim 5, further comprising a protection cover disposed on the opening of the annulus sidewall for covering the opening, wherein the encoding module is accommodated within the receiving space and sealed by the casing and the protection cover.

7. The information input and output device according to claim 6, wherein the annulus sidewall has an inner wall surface, and the inner wall surface has a second stepped part located at an end portion thereof and close to the opening, wherein the protection cover is disposed on the second stepped part.

8. The information input and output device according to claim 1, wherein the groove is a ring groove, and the magnetic wheel comprises a plurality of magnet units arranged sequentially.

9. The information input and output device according to claim 8, wherein each magnet unit includes a N pole and a S pole, and any two adjacent magnet units are attracted by each other, wherein the N poles and the S poles are arranged alternatively.

10. The information input and output device according to claim 1, wherein the magnetic wheel is fixed into the groove by ways of adhering or engaging.

11. The information input and output device according to claim 1, wherein the information processing unit includes two magnetic sensors, and the two magnetic sensors are disposed adjacent to an inner wall surface of the annulus sidewall.

12. The information input and output device according to claim 1, wherein the circuit board further comprises at least one integrated circuit electrically connected with the information processing unit through the circuit board.

13. The information input and output device according to claim 1, wherein the information input and output device is included in a wearable intelligent accessory.

14. An encoding module for an information input and output device, wherein the information input and output device comprises a casing, an outer ring body and a magnetic wheel, the casing comprises an annulus sidewall and a base, the outer ring body comprises a first surface and a single groove, the first surface is close to the annulus sidewall of the casing, the groove is formed on the first surface, and the magnetic wheel is fixed into the groove, the encoding module comprising:
a circuit board fixed on the base of the casing; and
an information processing unit fixed on the circuit board, wherein the outer ring body and the magnetic wheel are rotatably disposed around an outer wall surface of the annulus sidewall of the casing, when the outer ring body is rotated and the magnetic wheel is rotated with the outer ring body synchronously, and the information processing unit is configured to detect a number of times and a direction in changes of a magnetic field of the magnetic wheel and convert the detected results into a position information and a direction information.
